(19) United States
(12) Patent Application Publication
(10) Pub. No.: US 2011/0005400 A1
(43) Pub. Date: Jan. 13, 2011

(54) COFFEE MAKING KETTLE USING VENTURI

(76) Inventors: PAO-WU TIEN, Taipei City (TW); Yu-Mei TIEN LIN, Taipei City (TW)

Correspondence Address: LEONG C. LEI, PMB # 1008, 1839 YGNACIO VALLEY ROAD, WALNUT CREEK, CA, 94598, US

(21) Appl. No.: 12/499,106

(22) Filed: Jul. 8, 2009

(51) Int. Cl. A47J 31/02

(52) U.S. Cl. 99/298; 99/306

(57) ABSTRACT

Provided is a coffee making kettle using Venturi, including a kettle body having a bottom forming a through opening and defining a first chamber and a second chamber. The opening has an upper circumference from which two opposite inclined surfaces extend upward. Top edges of the inclined surfaces form a circular opening. The first chamber is located above the second chamber and is greater in volume than the second chamber. The second chamber is in communication with the through opening. When a paper filter that contains an object-to-be-brewed (such as coffee powders) is positioned in the kettle body and liquid (such as hot water) is added, the liquid is filtered by the paper filter and is guided by the inclined surfaces into the second chamber, so that the brewing liquid is subjected to the effect of Venturi to induce a pressure difference and increase of flowing speed.

### TECHNICAL FIELD OF THE INVENTION

The present invention generally relates to a coffee making kettle, and more particularly to a coffee making kettle using the effect of Venturi for making molecules of brewing liquid activated and excited inside a kettle body before it flows out so that brewing liquid can be extracted and the concentration controlled to make the brew better in taste, rich in flavor, and exhibiting smooth and soft residual feeling.

### DESCRIPTION OF THE PRIOR ART

The prosperity of modern cities brings about establishment of street corner cafes. Friends or office employees often get together at the cafes to establish a closer relationship by making and drinking coffee and tea. This is due to the fact that making or brewing coffee or tea is not quite time-consuming and requires no large machines, making it economic, convenient, and efficient. This makes it very popularized. However, the conventional coffee makers or tea brewers are of complicated structures and operation.

The present inventor has filed and granted a number of patent applications regarding beverage brewing devices, but is not completely satisfied with these designs and devoted himself in the development of novel and improved coffee brewing devices.

FIG. 11 of the attached drawings shows a conventional coffee maker 90, which structurally comprises a cup 91 that has a bottom forming a plurality of flow passages 92. To use, a user puts the cup 91 on a container 80 and position a paper filter 70 that contains object-to-be-brewed (such as coffee powders) 71 in the cup 91. When liquid (such as hot water) is added, a brew formed by the object-to-be-brewed and the liquid is filtered by the paper filter 70 and then flows out through the passages 92. However, the brewing liquid is caused to flow out directly and induces not temporary retention and infusion. Thus, the brewing liquid cannot be fully extracted. Further, since there is generally no pressure difference, molecules of the brewing liquid cannot be activated and excited. Thus, the conventional coffee maker 90 provides at most an effect of filtration through the paper filter 70 and offers no assistance to the activation and excitement of the molecules of the brewing liquid and thus providing the brew with better taste.

In view of the drawbacks of the conventional coffee makers, the present invention aims to provide a coffee making kettle that overcomes the drawbacks.

### SUMMARY OF THE INVENTION

An objective of the present invention is to provide a coffee making kettle using the effect of Venturi for making molecules of brewing liquid activated and excited inside a kettle body before it flows out so as to provide better taste. Structurally, the coffee making kettle comprises a kettle body having a bottom forming a through opening and defining a first chamber and a second chamber, the opening having an upper circumference from which two opposite inclined surfaces extend upward, top edges of the inclined surfaces forming a circular opening, the first chamber being located above the second chamber and greater than the second chamber, the second chamber being in communication with the through opening so that brewing liquid contained in the first chamber is guided to flow smoothly into the second chamber and the brewing liquid is subjected to effect of Venturi to induce a pressure difference and increase of flowing speed, making molecules of the brewing liquid activated and excited, and then flowing out through the through opening, whereby the brewing liquid can be extracted and the concentration controlled to make the brew better in taste, rich in flavor, and exhibiting smooth and soft residual feeling.

The first chamber of the coffee making kettle forms at least one raised rib.

The first chamber of the coffee making kettle forms at least one channel.

The second chamber of the coffee making kettle forms at least one extension chamber at an upper end thereof.

The through opening of the kettle body of the coffee making kettle has an outside diameter substantially identical to an outside diameter of the second chamber.

The through opening of the kettle body of the coffee making kettle receives therein a seat that defines a through hole for tight engagement with a water stopper.

The kettle body of the coffee making kettle a comprises a water stop control set therebelow for control water flow through the through opening, and the water stop control set is set below the kettle body in a movable manner.

The kettle body of the coffee making kettle has a lower circumference from which a protection section extends. The protection section of the kettle body has a diameter greater than the water stop control set, whereby the water stop control set is completely received in and covered by the protection section. The protection section forms a plurality of support legs.

The kettle body of the coffee making kettle forms a handle on an outside surface thereof.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is an exploded view of the present invention.

FIG. 3 is a cross-sectional view, taken from the front side, of the present invention.

FIG. 4 is a cross-sectional view, taken from a lateral side, of the present invention.

FIG. 5 is a perspective view showing the present invention receives a paper filter therein.

FIG. 6 is a lateral side cross-sectional view showing the operation of the present invention when liquid is blocked;

FIG. 7 is a front side cross-sectional view showing the operation of the present invention when liquid is blocked.

FIG. 8 is a front side cross-sectional view showing the operation of the present invention when liquid is allowed to discharge.

FIG. 9 is a schematic view illustrating Venturi formed by the present invention.

FIG. 10 is a cross-sectional view showing another embodiment of the present invention.

FIG. 11 is a cross-sectional view showing a conventional coffee maker.

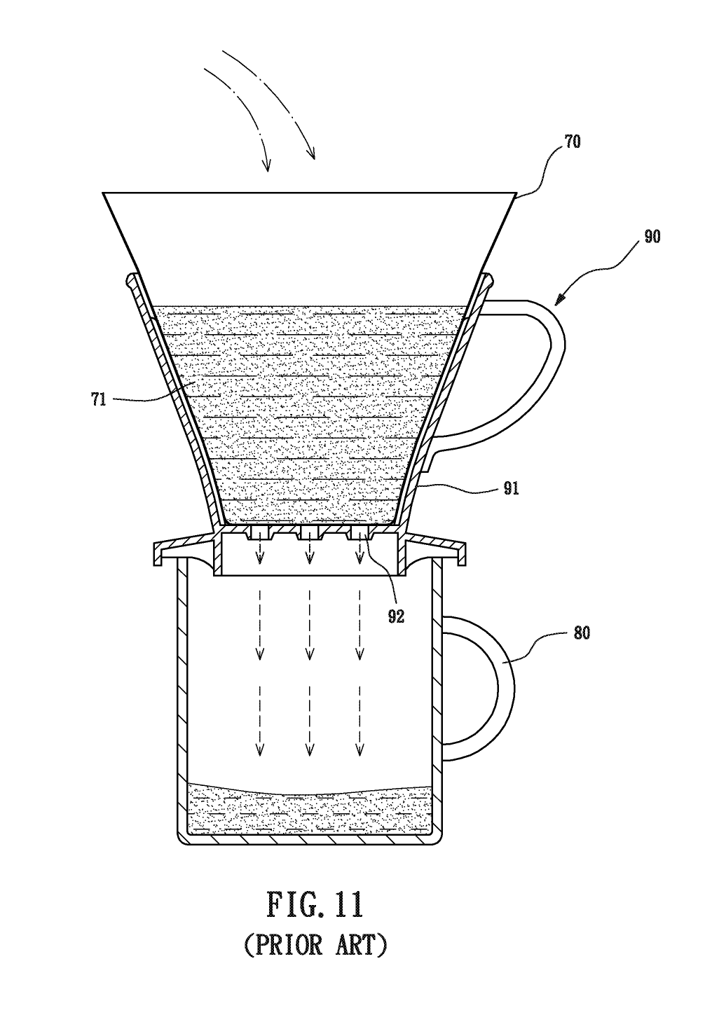

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

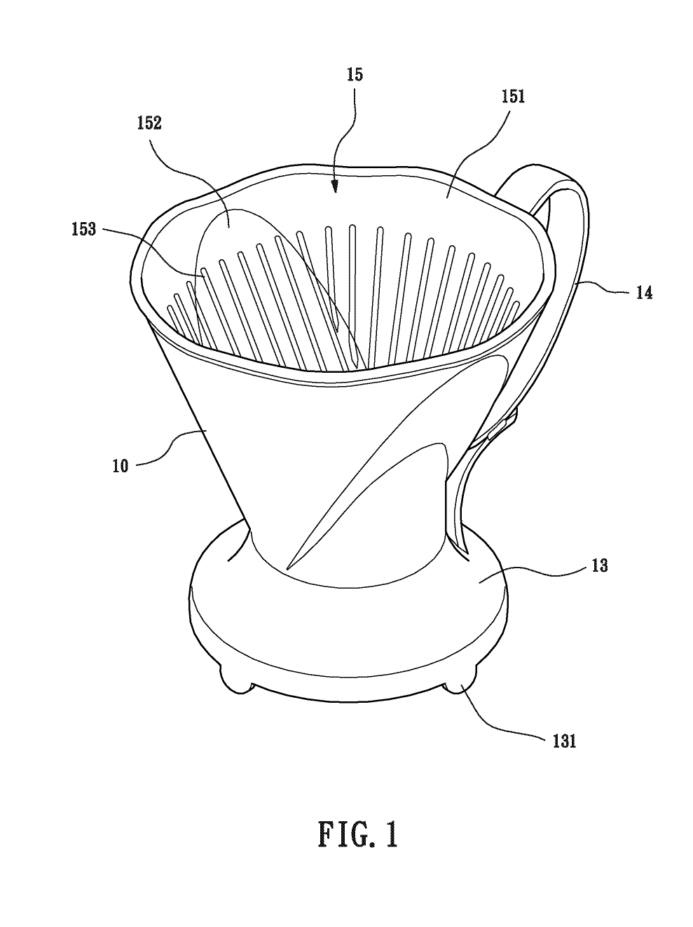

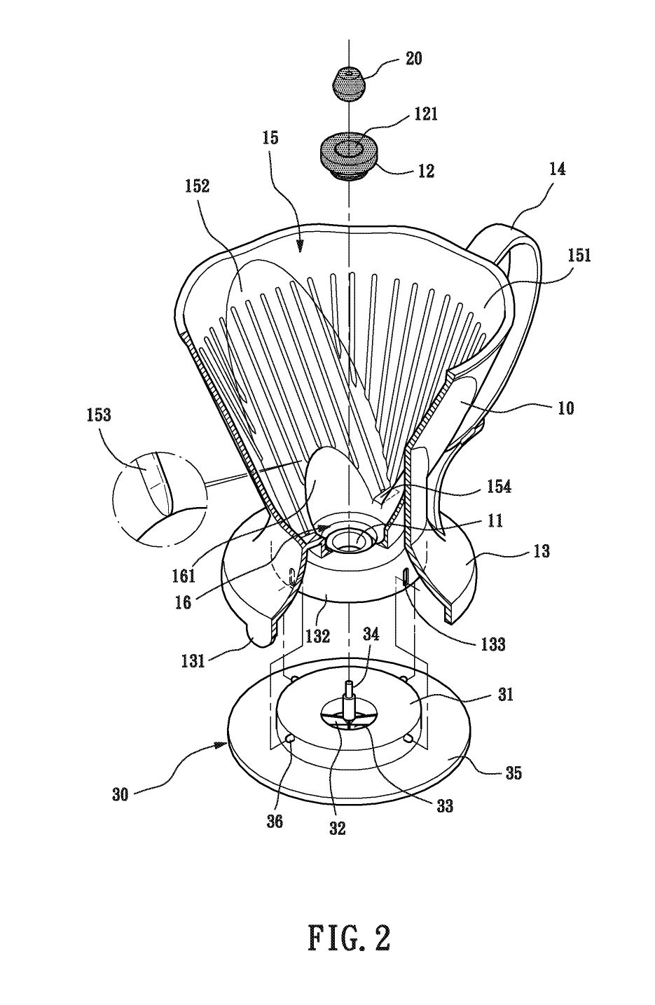

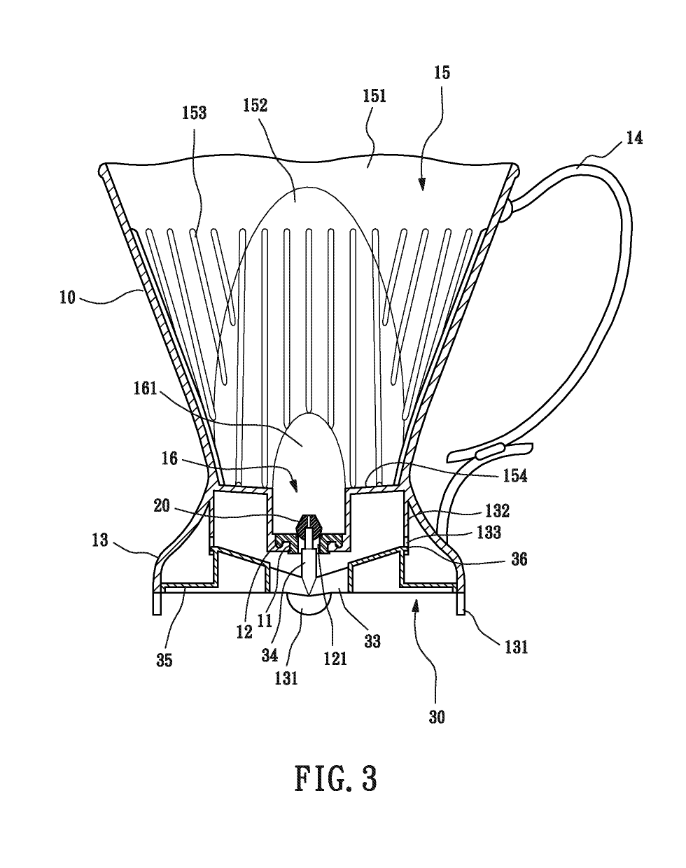

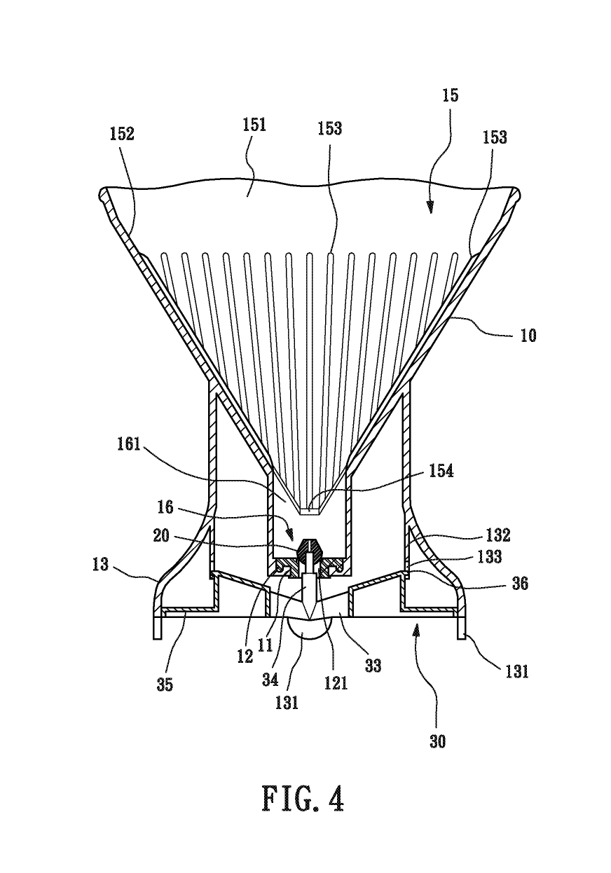

As shown in FIGS. 1-4, the present invention provides a coffee making kettle comprising a kettle body 10, a water stopper 20, and a water stop control set 30.

The kettle body 10 can receive object-to-be-brewed, such as coffee powders or tea leaves, and is formed in the shape of a container having an opening. A bottom inside the kettle body 10 forms a through opening 11, in which a seat 12, which is made of food-grade resilient silicone rubber and thus possessing resilient deformability and defines a through hole 121, is set for tightly engageable with the water stopper 20. The kettle body 10 has a lower circumference from which a protection section 13 extends. The protection section 13 of the kettle body 10 has a diameter greater than the water stop control set 30, whereby the water stop control set 30 is completely received in and covered by the protection section 13. The protection section 13 forms a plurality of support legs 131 that is equally spaced. Arranged inside the protection section 13 is a circumferential support ring 132, which defines a plurality of equally spaced slots 133. The kettle body 10 also forms, on an outside surface thereof, a handle 14 for a user's hand holding.

The water stopper 20 is made of food-grade silicone rubber and is positioned above the seat 12 for selectively plugging the through hole 121 of the seat 12 thereby preventing water leaking from the kettle body 10 in a normal condition.

The water stop control set 30 comprises a base 31 forming a plurality of web boards 32, openings 33, and a raised post 34 and an extension section 35 formed below the base 31 and horizontally extends. The base 31 has a circumference forming a plurality of projecting pegs 36 corresponding to the slots 133 of the protection section 13. The pegs 36 are fit into and movably retained in the slots 133. The kettle body 10 is made of food-grade plastics, so that the pegs 36, once fit into the slots 133, will not disengage therefrom, but are movable vertically in the slots 133, whereby the water stop control set 30 is set below the kettle body 10 and is vertically movable with respect to the kettle body 10. The openings 33 are defined between the web boards 32 to allow brewing liquid to flow therethrough. The post 34 has an upper end extending beyond the through hole 121 of the seat 12 to couple with the water stopper 20 so that upward movement of the post 34 pushes the water stopper 20 away from a plugging position within the through hole 121 of the seat 12 to release the plugged condition of the through hole 121.

The major features of the present invention are that the opening 11 has an upper circumference from which two opposite inclined surfaces 152 extend upward and top edges of the inclined surfaces 152 form a circular opening. The kettle body 10 forms therein a first chamber 15 and a second chamber 16. The first chamber 15 is located above the second chamber 16 and is greater in volume than the second chamber 16 so as to form a fundamental structure of Venturi. The first chamber 15 comprises an arc surface 151, which is expanded in an upper portion and narrowed down toward a lower portion, and a plurality of long strip like raised ribs 153. The arc surface 151 and the inclined surfaces 152 define a channel 154 at a lower intersection therebetween. The second chamber 16 has a circular outer circumference and comprises two opposite extension chambers 161 at an upper end thereof and the extension chambers 161 are connected to the inclined surfaces 152.

The opening 11 of the kettle body 10 has an outside diameter that is smaller than an outside diameter of the second chamber 16 or is substantially identical to the outside diameter of the second chamber 16.

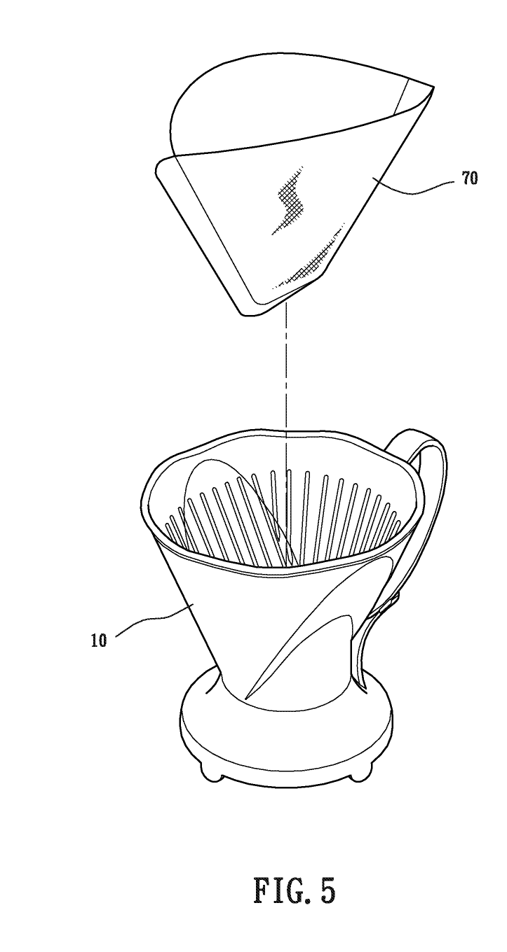

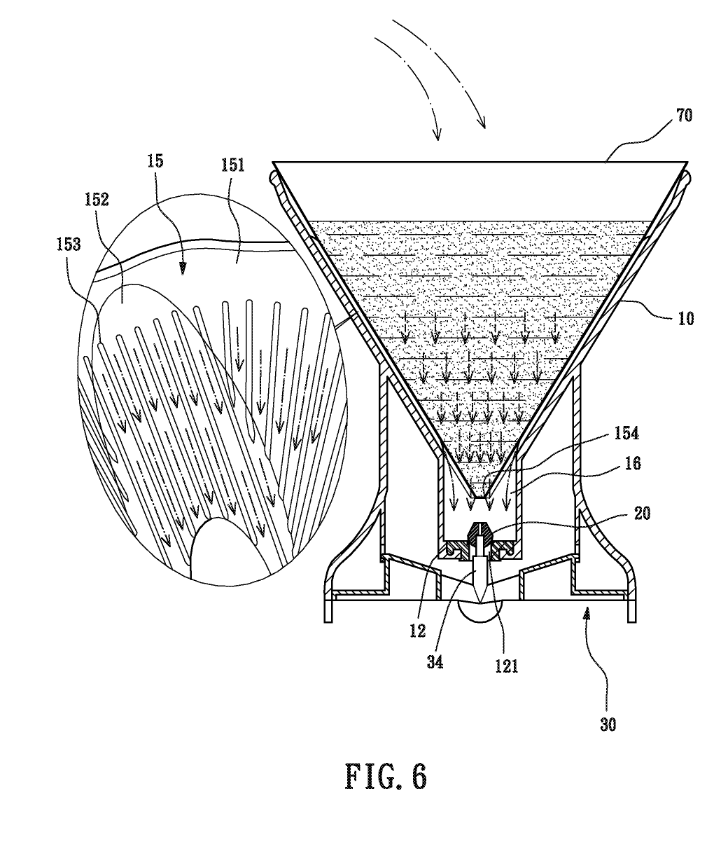

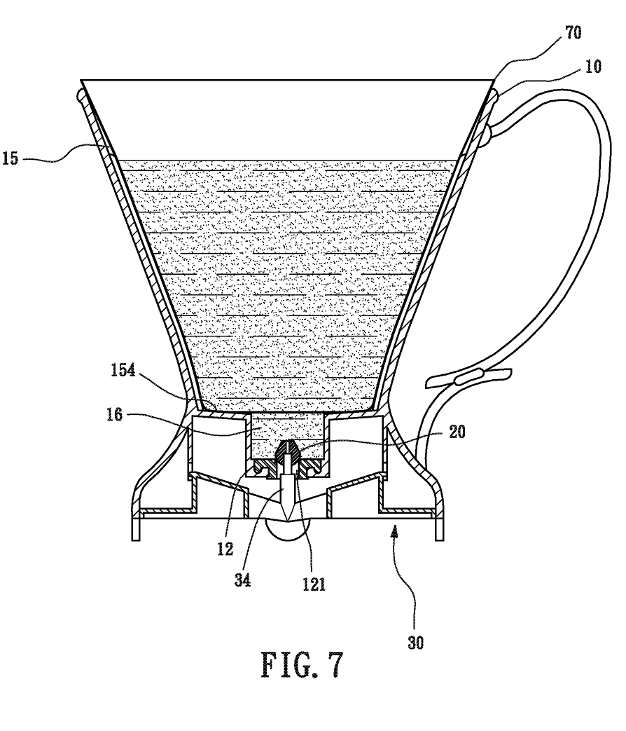

Referring to FIGS. 5-7, when used, the kettle body 10 is placed on a horizontal surface. With a conventional paper filter 70 that contains object-to-be-brewed (such as coffee powders) set in the kettle body 10 and liquid (such as hot water) added, the channel 154 receives and supports the outward expanded bottom section of the paper filter 70 and the brewing liquid passes through and is filtered by the paper filter 70 to form a brew that is guided by the arc surface 151, the inclined surfaces 152, and the ribs 153 of the first chamber 15 to flow smoothly into the second chamber 16.

The water stop control set 30 is driven downward by gravity. The water stopper 20 that is coupled to the post 34 has an outside diameter slightly greater than the through hole 121 of the seat 12, and consequently, the water stopper 20 blocks the through hole 121. The water stopper 20 is acted upon by the liquid pressure of the brewing liquid inside the kettle body 10 and the gravity of its own to completely block and seal the through hole 121 so that no liquid leaking therethrough is allowed and the brew formed by infusion of the coffee powders inside the kettle body 10 is completely stopped from flowing out. As such, water stop is realized and the brew can have sufficient time to form by infusion with the object-to-be-brewed inside the kettle body 10 so that a user may control the brew concentration and use the paper filter 70 to filter and extract the brewing liquid.

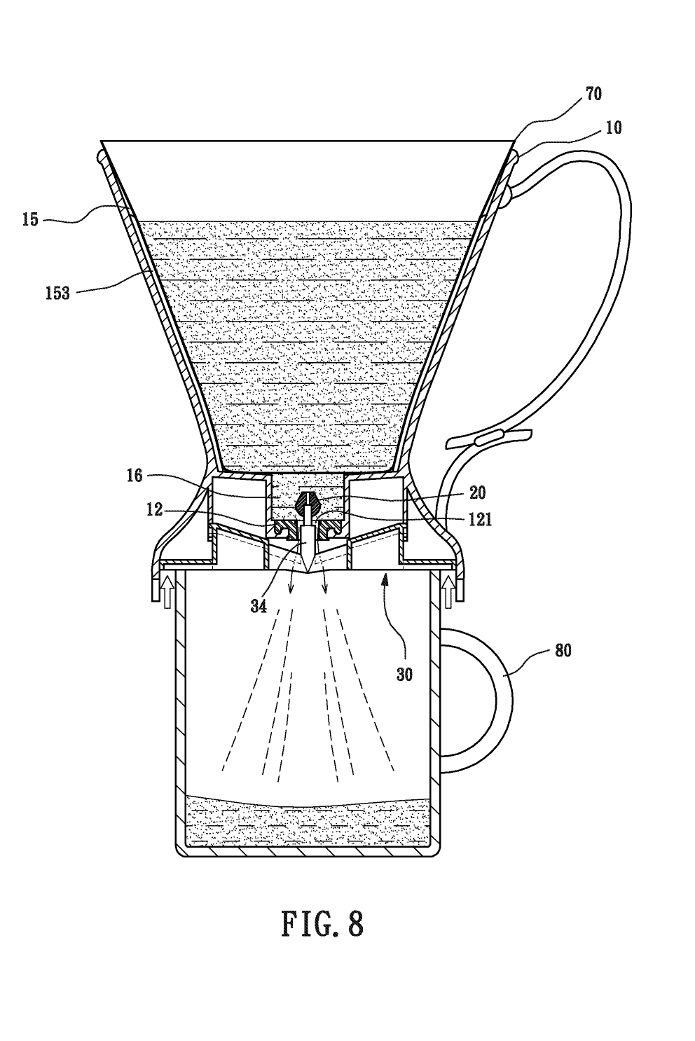

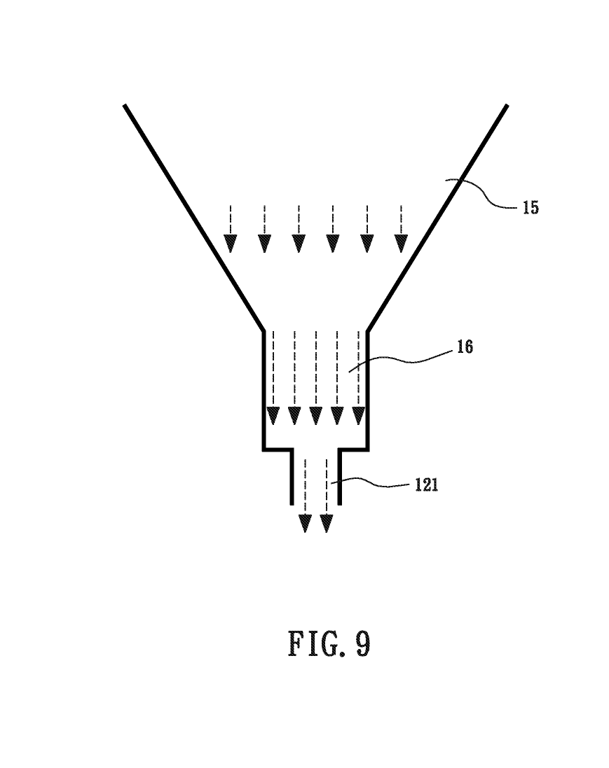

Referring to FIGS. 8 and 9, when the infusion of the object-to-be-brewed inside the kettle body 10 reaches a predetermined time (meaning control of the brew concentration), a simple kettle placement operation may be taken to place the kettle body 10 on a top of a container 80. Under this condition, the container 80 pushes upward the water stop control set 30, causing the water stop control set 30 to move upward and the post 34 driving the water stopper 20 away from the through hole 121 of the seat 12, whereby the brew that is formed through infusion and extraction of the object-to-be-brewed inside the kettle body 10 is allowed to flow through the through hole 121 and the water stop control set 30 to enter the container 80 for consuming.

It is noted here that when the brew flows from the first chamber 15 to the second chamber 16, due to the fact that the first chamber 15 is greater in volume than the second chamber 16, the brew is subjected to the influence of Venturi to induce a pressure difference and increase of flowing speed, so that the molecules of the brewing liquid are activated and excited, and then flow out through the through hole 121 of the seat 12. Due to the effect of separation by the ribs 153 of the first chamber 15, the paper filter 70 and an inside wall of the kettle body 10 is kept away from each other by a distance, which allows air to mix with the brewing liquid, making the brew better in taste, rich in flavor, and exhibiting smooth and soft residual feeling.

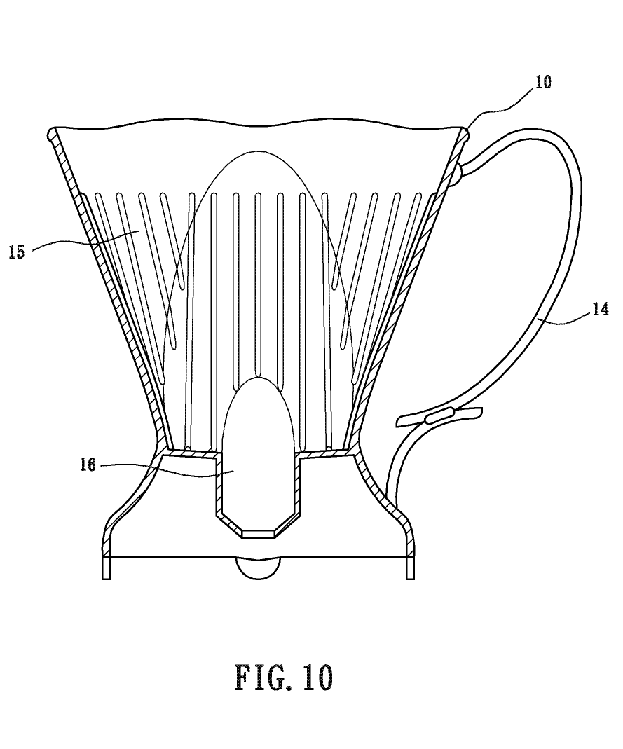

Referring to FIG. 10, another embodiment of the present invention is shown, wherein the water stopper 20 and the water stop control set 30 are omitted.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A coffee making kettle, comprising a kettle body having a bottom forming a through opening and defining a first chamber and a second chamber, the opening having an upper circumference from which two opposite inclined surfaces extend upward, top edges of the inclined surfaces forming a circular opening, the first chamber being located above the second chamber and greater than the second chamber, the second chamber being in communication with the through opening so that brewing liquid contained in the first chamber is guided to flow smoothly into the second chamber and the brewing liquid is subjected to effect of Venturi to induce a pressure difference and increase of flowing speed, making molecules of the brewing liquid activated and excited, and then flowing out through the through opening.

2. The coffee making kettle according to claim 1, wherein the first chamber forms at least one raised rib.

3. The coffee making kettle according to claim 1, wherein the first chamber forms at least one channel.

4. The coffee making kettle according to claim 1, wherein the second chamber forms at least one extension chamber at an upper end thereof.

5. The coffee making kettle according to claim 1, wherein the through opening has an outside diameter substantially identical to an outside diameter of the second chamber.

6. The coffee making kettle according to claim 1, wherein the through opening receives therein a seat that defines a through hole for tight engagement with a water stopper.

7. The coffee making kettle according to claim 1, wherein the kettle body comprises a water stop control set therebelow for control water flow through the through opening, the water stop control set being set below the kettle body in a movable manner.

8. The coffee making kettle according to claim 7, wherein the kettle body has a lower circumference from which a protection section extends, the protection section of the kettle body having a diameter greater than the water stop control set, whereby the water stop control set is completely received in and covered by the protection section, the protection section forming a plurality of support legs.

9. The coffee making kettle according to claim 1, wherein the kettle body forms a handle on an outside surface thereof.
